(19) United States
(12) Patent Application Publication
(10) Pub. No.: US 2005/0079861 A1
(43) Pub. Date: Apr. 14, 2005

(54) Method of saving message contents in phone book in a mobile terminal

(75) Inventor: Seok-Hun Lim, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/858,258

(22) Filed: Jun. 1, 2004

(30) Foreign Application Priority Data
Oct. 11, 2003 (KR) 70795-2003

(51) Int. Cl. H04Q 7/20

(52) U.S. Cl. 455/412.1; 455/466; 455/550.1

(57) ABSTRACT

A method of automatically saving message contents in a phone book in a mobile terminal is disclosed. In the method, it is decided whether a phone book save key has been entered, with the message contents displayed. Upon input of the phone book save key, phone book information is extracted from the message contents, and displayed. With the phone book information displayed, it is decided whether a save key has been entered. Upon input of the save key, the displayed phone book information is saved in a predetermined field of a phone book saving area.

### PRIORITY

This application claims priority under 35 U.S.C. § 119 to an application entitled “Method of Saving Message Contents in Phone Book in a Mobile Terminal” filed in the Korean Intellectual Property Office on Oct. 11, 2003 and assigned Serial No. 2003-70795, the contents of which are incorporated herein by reference.

### BACKGROUND OF THE INVENTION

1. Field of the Invention

The present invention relates generally to a phone book saving method, and in particular, to a method of automatically saving message contents in a phone book.

2. Description of the Related Art

Along with the rapid proliferation of mobile terminals due to their convenient portability, service providers and terminal manufacturers are competing to develop mobile terminals with advanced functions to secure more users. For example, the mobile terminals offer various functions such as a phone book, games, a scheduler, short message service, Internet service, e-mail service, and morning call service.

Among those functions, short message and phone book services are widely used. The phone book service has been developed from the simple function of saving a single phone number to being able to save household phone numbers, mobile phone numbers, office phone numbers, URLs (Uniform Resource Locators), e-mail addresses, and fax numbers.

Upon input of a Menu key in a Message Read window, a conventional mobile terminal provides a pop-up window containing menu items such as “1. Reply 2. Resend 3. Delete 4. Save Number.” If item 4 is selected, a “Sender Number” that is typically provided in a message is saved in the phone book. To save the phone number (or URL, e-mail address, etc.) of the sender in the phone book, a user must memorize the number or write the number down, and then register or enter the number manually after a corresponding phone application (Phone Book Save menu).

As described above, to save a phone number, URL, or an e-mail address included in a short message, the user has to memorize the information or write the information down, manipulate keys to move to the Phone Book Save menu, and enter the information manually in the phone application.

### SUMMARY OF THE INVENTION

It is, therefore, an object of the present invention to provide a method of automatically recognizing phone book information included in a message and saving the phone book information in a phone book in a mobile terminal.

It is another object of the present invention to provide a method of automatically recognizing a phone number, URL, e-mail address, and avatar (i.e. a digital representation of a person, as used in a virtual environment or as can be transmitted from a mobile terminal) in a message and saving them in a phone book in a mobile terminal.

It is a further object of the present invention to provide a method of automatically recognizing phone book information included in a message using indexes and saving them in a phone book in a mobile terminal.

The above objects are achieved by a method of automatically saving message contents in a phone book in a mobile terminal, as disclosed below. According to one aspect of the present invention, it is decided whether a phone book save key has been entered, with the message contents displayed. Upon input of the phone book save key, phone book information is extracted from the message contents and displayed. With the phone book information displayed, it is decided whether a save key has been entered. Upon input of the save key, the displayed phone book information is saved in a predetermined field of a phone book saving area.

According to another aspect of the present invention, it is decided whether a phone book save key has been entered, with the message contents displayed. Upon input of the phone book save key, the message contents are displayed in an edit window. Upon input of an index with the edit window displayed, the index is inserted to a cursor position. With the edit window displayed, it is decided whether a save key has been entered. Upon input of the save key, the index is detected from the displayed message contents in the edit window, and phone book information following the index is extracted and saved in a predetermined field of a phone book saving area.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile terminal for performing the method of the present invention;

FIG. 2 is a flowchart illustrating an operation for automatically saving message contents in a phone book in the mobile terminal according to an embodiment of the present invention;

FIGS. 3A to 3D illustrate displayed windows involved with automatically recognizing phone book information included in a message and saving the phone book information in a phone book according to the present invention; and

FIGS. 4A to 4D illustrate displayed windows involved with automatically recognizing phone book information included in a message using indexes and saving the phone book information in the phone book according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail to avoid obscuring the invention with unnecessary detail.

The present invention provides a method of automatically saving phone book information included in a received message in a phone book of a mobile terminal. The phone book information can include a home phone number, mobile phone number, office phone number, URL, e-mail address, fax number, and avatar. The term “message” used herein includes an SMS (Short Message Service) message, e-mail, MMS (Multimedia Messaging System) message, and EMS (Enhanced Messaging Service) message.

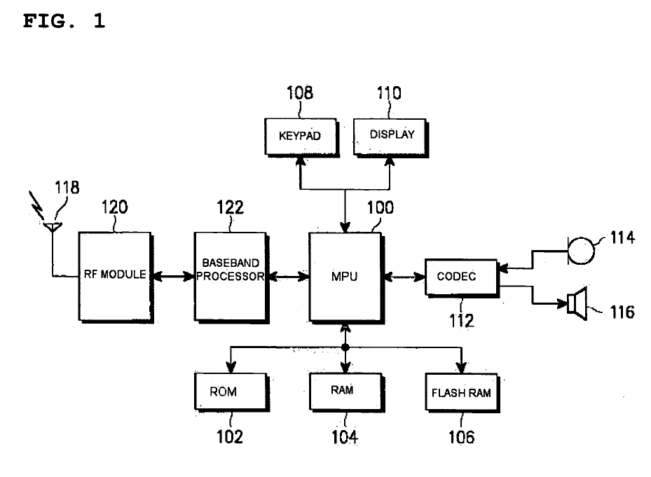

FIG. 1 is a block diagram of a mobile terminal for performing the method of to the present invention. The mobile terminal can be any of a cellular phone, PCS (Personal Communication System), PDA (Personal Digital Assistant), and IMT-2000 (International Mobile Communication-2000) terminal. The following description is provided based on the general structure of such terminals.

Referring to FIG. 1, a microprocessor unit (MPU) 100 provides overall control to the mobile terminal. The MPU 100 is responsible for processing and controlling voice and data communications, and automatically saving phone book information included in a received message in a phone book, in addition to its general functions, according to the present invention. A description of the general operations of the MPU 100 is known by those of skill in the art and is not provided here.

A ROM (Read Only Memory) 102 stores programs and reference data utilized for the operation of the MPU 100. Particularly, the ROM 102 stores a program for automatically saving the phone book information in the phone book according to the present invention. A RAM (Random Access Memory) 104 provides a working memory for the MPU 100, for storing temporary data generated during the execution of the programs. A flash ROM 106 stores updatable data to be kept, such as the phone book, sent messages, and received messages.

A keypad 108 has digit keys 0 to 9, a Menu key, a Cancel (Delete) key, an OK key, a Talk key, an End key, an Internet key, and navigation (or directional) keys (/ / [symbol] / [symbol] ). The keypad 108 provides key input data which corresponds to a user-pressed key to the MPU 100. A display 110 displays state information generated during the operation of the mobile terminal, a limited number of characters, moving pictures, and still images. An LCD (Liquid Crystal Display) can be used for the display 110.

A CODEC (Coder-Decoder) 112 is connected to the MPU 100. A speaker 116 and a microphone 114 are connected to the CODEC 112 to collectively form a voice input/output block for performing functions such as a voice call and voice recording. The CODEC 112 converts PCM (Pulse Code Modulation) data received from the MPU 100 to an analog voice signal and outputs the converted data through the speaker 116. The CODEC 112 also converts a voice signal received through the microphone 114 to PCM data and feeds the PCM data to the MPU 100.

An RF (Radio Frequency) module 120 downconverts an RF frequency signal received from an antenna 118 and provides the signal to a baseband processor 122. The RF module 120 upconverts a baseband frequency signal received from the baseband processor 122 and transmits the signal to the antenna 118. The baseband processor 122 processes a baseband signal between the RF unit 120 and the MPU 100. For example, the baseband processor 122 channel-encodes and spreads transmission data, and despreads and channel-decodes received data.

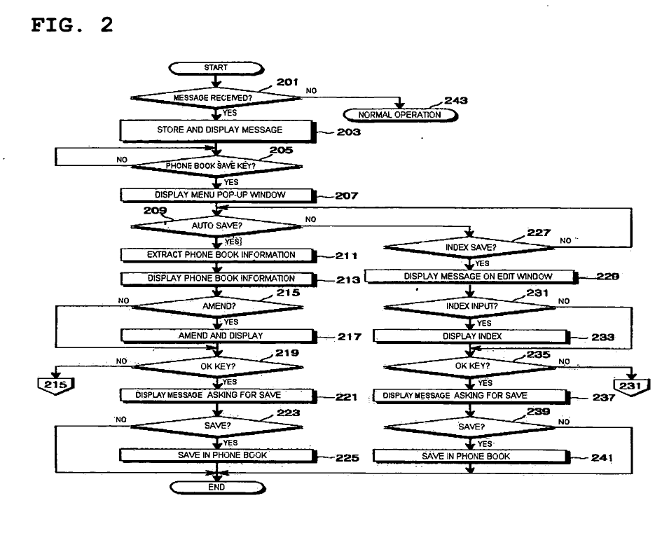

FIG. 2 is a flowchart illustrating an operation for automatically saving message contents in a phone book in the mobile terminal according to an embodiment of the present invention.

Referring to FIG. 2, the MPU 100 decides whether a message has been received from a base station in step 201. In the absence of a received message, the MPU 100 operates in a normal mode, such as an idle mode in step 243. Upon receipt of a message, the MPU 100 alerts a user of the incoming message via a preset alert mode, stores the received message in a predetermined storage area, and displays the contents of the message on the display 110 in step 203.

With the message contents displayed, the MPU 100 decides whether the user has entered a phone book save key in step 205. The phone book save key can be implemented as one of menu items provided under a menu on the display (e.g. “1. Reply 2. Resend 3. Delete 4. Save in Phone Book”), or by using a * key, a # key, or a digit key not otherwise used in a message read mode.

Upon input of the phone book save key, the MPU 100 displays a pop-up window, which includes menu items related with saving methods, preferably in the left lower portion of the screen in step 207. For example, the pop-up window can display “1. Auto Save 2. Index Save”. With the menu pop-up window displayed, the MPU 100 decides whether item 1 (Auto Save) has been selected in step 209. If item 1 is not selected, the MPU 100 decides whether item 2 (Index Save) is selected in step 227.

Upon selection of Auto Save, the MPU 100 extracts phone book information from the message contents in step 211. As stated before, the phone book information can be a phone number, URL, e-mail address, or avatar. The phone number is extracted by detecting digit data in the message contents, the ULR is extracted by detecting a predetermined character string “www”, the e-mail address is extracted by detecting a special character “@”, and the avatar is extracted by detecting image data.

After extracting the phone book information, the MPU 100 displays the extracted phone book information on the display 110 in step 213, and decides whether a key for amending the displayed phonebook information has been received in step 215. If manipulation of a key for amending the displayed phonebook information is not sensed, the MPU 100 decides whether an OK key has been tapped in step 219. On the other hand, if in step 215 manipulation of a key for amending the displayed phonebook information is sensed, the MPU 100 amends the phone book information and displays the amended data in step 217 and proceeds to step 219. If the OK key has not been tapped in step 219, the MPU 100 returns to step 215. Upon input of the OK key, the MPU 100 proceeds to step 221.

In step 221, the MPU 100 displays a message asking whether the phone book information on the window is to be saved. For example, the message is “Will you save it in phone book? Yes/No”. The MPU 100 decides whether Yes is selected in step 223. If No is selected, the MPU 100 ends the procedure. If Yes is selected, the MPU 100 saves the displayed phone book information in predetermined fields in a phone book saving area in step 225. At the same time, the phone book saving result can be displayed.

Meanwhile, if Auto Save was not selected in step 209, the MPU 100 decides whether Index Save is selected in step 227. If Index Save is not selected, the MPU 100 returns to step 209. To the contrary, if Index Save is selected, the MPU 100 displays the contents of the received message in an edit window in step 229.

With the message contents displayed in the edit window, the MPU 100 decides whether an index has been received in step 231. In the absence of an index, the MPU 100 decides whether the OK key has been tapped in step 235. Upon input of an index, the MPU 100 inserts the index in the message contents in step 233.

Preferred methods for entering an index are as follows. <N> is as an index for identifying a name, <T> is an index for identifying a phone number, <U> is an index for identifying a URL, <E> is an index for identifying an e-mail address, and <A> is an index for identifying an avatar. Alternatively, indexes need not be assigned to avatars because avatars are image data and thus can be easily identified. That is, the user inserts indexes preset by a terminal manufacturer or a service provider before phone book information and the mobile terminal extracts the phone book information by checking the indexes in message contents. On the other hand, the user can enter the indexes manually or by using a pop-up window. In the latter case, a pop-up window containing a plurality of indexes appears by moving a cursor to an intended position and entering the Menu key, and a desired index is inserted using a directional key and the OK key.

After inserting the indexes, the MPU 100 decides whether the OK key has been tapped in step 235. If it has not, the MPU 100 returns to step 231. Upon input of the OK key, the MPU 100 proceeds to step 237.

In step 237, the MPU 100 displays a message asking whether the phone book information is to be saved on the window. For example, the message is “Will you save it in phone book? Yes/No”. The MPU 100 decides whether Yes is selected in step 239. If No is selected, the MPU 100 ends the procedure. If Yes is selected, the MPU 100 extracts the indexes from the displayed message contents and saves the phone book information following the indexes in the predetermined fields in the phone book saving area in step 241. At the same time, the phone book saving result can be displayed.

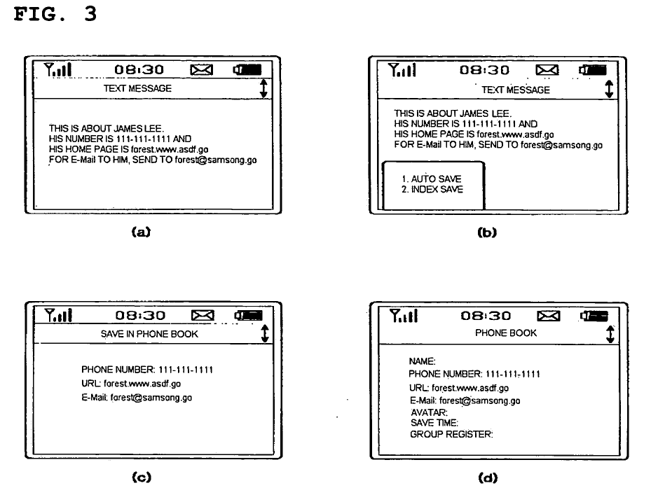

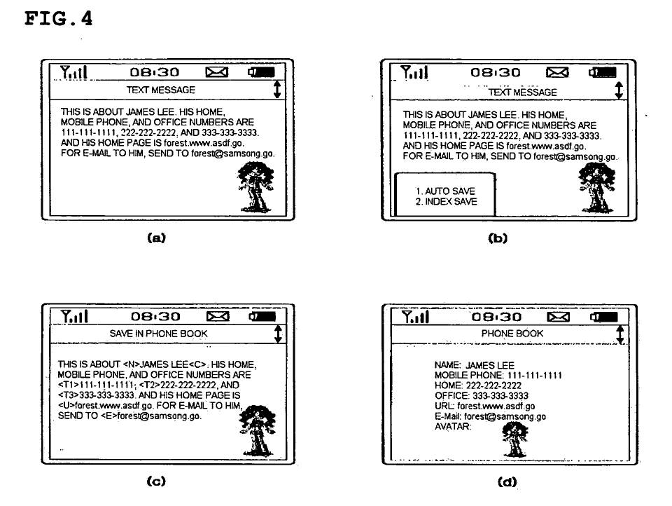

For a better understanding of the present invention, actual exemplary applications will be described in connection with FIGS. 3A to 4D. FIGS. 3A to 3D, which illustrate windows displayed when phone book information included in message contents is automatically recognized and saved in the phone book.

FIG. 3A illustrates a window having message contents displayed thereon. As illustrated, the message contains a phone number (111-111-1111), a URL (forest.www.asdf.go), and an e-mail address (forest@samsong.go).

If the phone book save key is entered when the window of FIG. 3A is displayed, a menu pop-up window appears in the left lower portion as illustrated in FIG. 3B. Upon selection of Auto Save in the pop-up window, the phone book information (i.e. phone number, URL, and e-mail address) extracted from the message contents is displayed as illustrated in FIG. 3C. As described before, the phone number is extracted by detecting digit data, the URL is extracted by detecting a certain string of characters “www”, and the e-mail address is extracted by detecting the special character “@”.

Upon input of the OK key with the window of FIG. 3C displayed, a message asking whether the phone book information is to be saved (e.g. Will you save it in phone book? Yes/No) is displayed. If Yes (save) is selected, the extracted phone book information is saved in preset fields of the phone book saving area, and the phone book saving result is displayed, as illustrated in FIG. 3D.

FIGS. 4A to 4D illustrate windows displayed when phone book information included in message contents is automatically recognized and saved in the phone book, using indexes.

FIG. 4A illustrates a window having message contents displayed thereon. As illustrated, the message contains phone numbers (111-111-1111, 222-222-2222, and 333-333-3333), a URL (forest.www.asdf.go), an e-mail address (forest@samsong.go), and an avatar.

If the phone book save key is entered with the window of FIG. 4A displayed, a menu pop-up window containing Auto Save and Index Save appears in the left lower portion, as illustrated in FIG. 4B. Upon selection of Index Save in the pop-up window, an edit window is displayed to allow the user to edit the message contents. The user inserts indexes before corresponding phone book information in the message contents. As described before, he inserts <N> before the name, <T> before the phone numbers, <U> before the URL, <E> before the e-mail address, and <A> before the avatar. To distinguish the name from another character string, an index <C> is further added after the name. In addition, to discriminate the phone numbers from one another, <T1>, <T2> and <T3> are added before the home phone number, mobile phone number, and office phone number, respectively.

FIG. 4C illustrates the message contents with the indexes inserted therein. Upon input of the OK key with the window of FIG. 4C displayed, a message asking whether the phone book information is to be saved (e.g. Will you save it in phone book? Yes/No) is displayed. If Yes (save) is selected, the indexes are detected and the phone book information following the indexes is saved in preset fields of the phone book saving area, and the phone book saving result is displayed as illustrated in FIG. 4D.

As described above, the present invention advantageously facilitates saving phone book information (phone number, URL, e-mail address, avatar, etc.) included in a received message (SMS, e-mail, MMS, EMS, etc.) in a phone book. Therefore, a user does not need memorize or write down the phone book information and suffer the inconvenience of manually entering the phone book information. Especially, the index-based search can be applied to other fields using an edit window.

While the invention has been shown and described with reference to a certain preferred embodiment thereof, it will be understood by those skilled in the art that various changes in form and details may be made therein without departing from the spirit and scope of the invention as defined by the appended claims.

1. A method of automatically saving message contents in a phone book in a mobile terminal, comprising the steps of:
deciding whether a phone book save key has been entered, when the message contents are displayed;
extracting phone book information from the message contents, upon input of the phone book save key, and displaying the extracted phone book information;
deciding whether a save key has been entered, when the phone book information is displayed; and
saving the displayed phone book information in a predetermined field of a phone book saving area, upon input of the save key.

2. The method of claim 1, wherein the phone book information includes a phone number, a URL (Uniform Resource Locator), an e-mail address, and an avatar.

3. The method of claim 1, wherein the message is one of an SMS (Short Message Service) message, an e-mail, an MMS (Multimedia Messaging System) message, and an EMS (Enhanced Messaging Service) message.

4. A method of automatically saving message contents in a phone book in a mobile terminal, comprising the steps of:
deciding whether a phone book save key has been entered, when the message contents are displayed;
displaying the message contents in an edit window upon input of the phone book save key;
inserting an index to a cursor position upon index input, with the edit window displayed;
deciding whether a save key has been entered, when the edit window is displayed; and
detecting the index from the displayed message contents in the edit window, upon input of the save key, extracting phone book information following the index, and saving the extracted phone book information in a predetermined field of a phone book saving area.

5. The method of claim 4, wherein the phone book information includes a phone number, a URL (Uniform Resource Locator), an e-mail address, and an avatar.

6. The method of claim 4, wherein the message is one of an SMS (Short Message Service) message, an e-mail, an MMS (Multimedia Messaging System) message, and an EMS (Enhanced Messaging Service) message.
